(19) United States
(12) Patent Application Publication
(10) Pub. No.: US 2020/0149897 A1
(43) Pub. Date: May 14, 2020

(54) METHOD AND APPARATUS FOR COLLECTING DATA

(71) Applicant: Baidu Online Network Technology (Beijing) Co., Ltd., Beijing (CN)

(72) Inventors: Wei XIONG, Beijing (CN); Xuning CAI, Beijing (CN)

(21) Appl. No.: 16/670,622

(22) Filed: Oct. 31, 2019

(30) Foreign Application Priority Data
Nov. 9, 2018 (CN) 201811333321.8

(51) Int. Cl. G01C 21/32; G01C 21/34; G06K 9/00; G05D 1/02; G06F 16/29

(52) U.S. Cl. CPC G01C 21/32; G01C 21/3453; G05D 2201/0213; G05D 1/0274; G06F 16/29; G06K 9/00791

(57) ABSTRACT

Embodiments of the present disclosure relate to a method and apparatus for collecting data. The method can include: receiving a map data collection instruction for a target road segment; dividing the target road segment to obtain at least one sub-road segment; and sending information of the at least one sub-road segment to at least one collection vehicle, to cause the at least one collection vehicle to collect map data of the at least one sub-road segment.

### CROSS-REFERENCE TO RELATED APPLICATIONS

This application claims priority to Chinese Application No. 201811333321.8, filed on Nov. 9, 2018 and entitled “Method and Apparatus for Collecting Data,” the entire disclosure of which is hereby incorporated by reference.

### TECHNICAL FIELD

Embodiments of the present disclosure relate to the field of computer technology, and specifically to a method and apparatus for collecting data.

### BACKGROUND

When a road facility and an environment change, it is required to update an electronic map. In the existing technology, a map update needs to be manually discovered, and then a collection scheme is started to update the electronic map. However, there are many processes and links, and the cycle is long, and thus the effectiveness of the update is low.

### SUMMARY

Embodiments of the present disclosure propose a method and apparatus for collecting data.

In a first aspect, some embodiments of the present disclosure provide a method for collecting data. The method includes: receiving a map data collection instruction for a target road segment; dividing the target road segment to obtain at least one sub-road segment; and sending information of the at least one sub-road segment to at least one collection vehicle, to cause the at least one collection vehicle to collect map data of the at least one sub-road segment.

In some embodiments, the dividing the target road segment to obtain at least one sub-road segment includes: determining a length of the target road segment; and dividing the target road segment according to the length of the target road segment, to obtain the at least one sub-road segment, a length of the sub-road segment being less than a first preset value.

In some embodiments, the target road segment includes at least one road crossing point. The dividing the target road segment to obtain at least one sub-road segment includes: dividing the target road segment according to the at least one road crossing point in the target road segment, to obtain the at least one sub-road segment, a number of road crossing points included in the sub-road segment being less than a second preset value.

In some embodiments, the sending information of the at least one sub-road segment to at least one collection vehicle includes: acquiring a driving route of the at least one collection vehicle, to obtain at least one driving route; using, in response to determining a driving route of the at least one driving route including a sub-road segment of the at least one sub-road segment, a collection vehicle corresponding to the driving route including the sub-road segment of the at least one sub-road segment as a target collection vehicle; and sending information of the sub-road segment included in the driving route to the target collection vehicle.

In some embodiments, the method further includes: acquiring the map data collected by the at least one collection vehicle; and generating, according to the map data, an electronic map for the target road segment.

In a second aspect, some embodiments of the present disclosure provide an apparatus for collecting data. The apparatus includes: an instruction receiving unit, configured to receive a map data collection instruction for a target road segment; a road segment dividing unit, configured to divide the target road segment to obtain at least one sub-road segment; and an information sending unit, configured to send information of the at least one sub-road segment to at least one collection vehicle, to cause the at least one collection vehicle to collect map data of the at least one sub-road segment.

In some embodiments, the road segment dividing unit is further configured to: determine a length of the target road segment; and divide the target road segment according to the length of the target road segment, to obtain the at least one sub-road segment, a length of the sub-road segment being less than a first preset value.

In some embodiments, the target road segment includes at least one road crossing point. The road segment dividing unit is further configured to: divide the target road segment according to the at least one road crossing point in the target road segment, to obtain the at least one sub-road segment, a number of road crossing points included in the sub-road segment being less than a second preset value.

In some embodiments, the information sending unit includes: a route acquiring module, configured to acquire a driving route of the at least one collection vehicle, to obtain at least one driving route; a target determining module, configured to use, in response to determining a driving route of the at least one driving route including a sub-road segment of the at least one sub-road segment, a collection vehicle corresponding to the driving route including the sub-road segment of the at least one sub-road segment as a target collection vehicle; and an information sending module, configured to send information of the sub-road segment included in the driving route to the target collection vehicle.

In some embodiments, the apparatus further includes: a data acquiring unit, configured to acquire the map data collected by the at least one collection vehicle; and a map generating unit, configured to generate, according to the map data, an electronic map for the target road segment.

In a third aspect, some embodiments of the present disclosure provide a server. The server includes: one or more processors; and a storage device, configured to store one or more programs. The one or more programs, when executed by the one or more processors, cause the one or more processors to implement the method described in any embodiment in the first aspect.

In a fourth aspect, some embodiments of the present disclosure provide a computer readable medium storing a computer program. The program, when executed by a processor, implements the method described in any embodiment in the first aspect.

According to the method and apparatus for collecting data provided by some embodiments of the present disclosure, the map data collection instruction for the target road segment maybe first received. Then, the target road segment is divided into the at least one sub-road segment. Finally, the information of the at least one sub-road segment is sent to the at least one collection vehicle, to cause the at least one collection vehicle to collect the map data of the at least one sub-road segment. Thus, the task of collecting the map data of the target road segment may be distributed to a plurality of collection vehicles, thereby improving the collection efficiency of the map data.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an example system architecture in which an embodiment of the present disclosure may be implemented;

FIG. 2 is a flowchart of a method for collecting data according to an embodiment of the present disclosure;

FIG. 3 is a schematic diagram of an application scenario of the method for collecting data according to an embodiment of the present disclosure;

FIG. 4 is a flowchart of the method for collecting data according to another embodiment of the present disclosure;

FIG. 5 is a schematic structural diagram of an apparatus for collecting data according to an embodiment of the present disclosure; and

FIG. 6 is a schematic structural diagram of a computer system adapted to implement a server according to embodiments of the present disclosure.

### DETAILED DESCRIPTION OF EMBODIMENTS

The present disclosure will be described below in detail by combining the accompanying drawings. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that some embodiments in the present disclosure and some features in the disclosure may be combined with each other on a non-conflict basis. Features of the present disclosure will be described below in detail with reference to the accompanying drawings and in combination with embodiments.

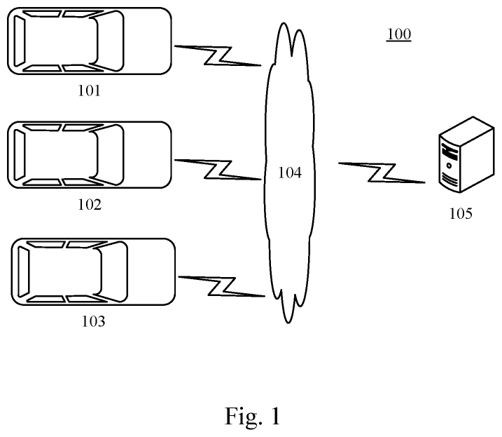

FIG. 1 shows an example system architecture 100 in which a method for collecting data or an apparatus for collecting data according to an embodiment of the present disclosure may be implemented.

As shown in FIG. 1, the system architecture 100 may include vehicles 101, 102 and 103, a network 104 and a server 105. The network 104 serves as a medium providing a communication link between the vehicles 101, 102 and 103 and the server 105. The network 104 may include various types of connections, for example, wired or wireless communication links, or optical fiber cables.

The vehicles 101, 102 and 103 may interact with the server 105 via the network 104, to receive or send a signal, etc. Various electronic apparatuses (e.g., an image collection apparatus, a sensor, or a vehicle controller) may be installed on the vehicles 101, 102 and 103. The sensor may be used to collect external environment data of the vehicles 101, 102 and 103, and the environment data maybe used as map data for making a map.

The vehicles 101, 102 and 103 may be various kinds of vehicles, including, but not limited to, a large passenger bus, a tractor, a city bus, a medium passenger bus, a large truck, a compact car, a compact automatic-gear car, an autonomous driving vehicle or other smart vehicles.

The server 105 may be a server providing various kinds of services, for example, a backend server determining a road segment to be collected by the vehicles 101, 102 and 103. The backend server may process a target road segment after receiving a map data collection instruction, and feed back the processing result (e.g., a sub-road segment) to the vehicles 101, 102 and 103.

It should be noted that the server 105 may be hardware or software. When being the hardware, the server 105 may be implemented as a distributed server cluster composed of a plurality of servers, or as a single server. When being the software, the server 105 may be implemented as a plurality of pieces of software or a plurality of software modules (e.g., software or software modules for providing a distributed service), or as a single piece of software or a single software module, which will not be specifically defined here.

It should be noted that the method for collecting data provided by some embodiments of the present disclosure is generally performed by the server 105. Correspondingly, the apparatus for collecting data is generally provided in the server 105.

It should be appreciated that the numbers of the vehicles, the networks, and the servers in FIG. 1 are merely illustrative. Any number of vehicles, networks, and servers may be provided based on actual requirements.

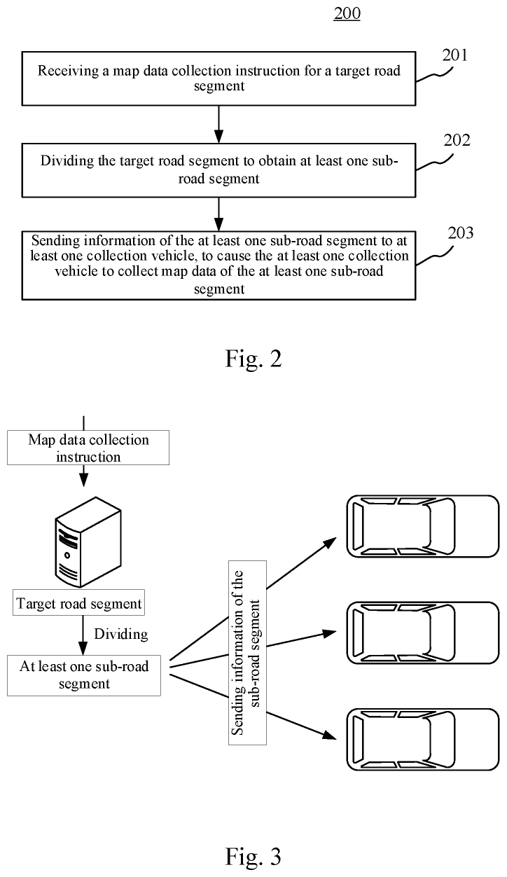

Further referring to FIG. 2, FIG. 2 illustrates a flow 200 of a method for collecting data according to an embodiment of the present disclosure. The method for collecting data in this embodiment includes the following steps.

Step 201, receiving a map data collection instruction for a target road segment.

In this embodiment, an executing body (e.g., the server 105 shown in FIG. 1) of the method for collecting data may receive the map data collection instruction for the target road segment by means of a wired or wireless connection. Here, the target road segment refers to a road segment for which the map data is to be collected. The map data refers to data for constructing an electronic map, and the data may include road information, building information, traffic sign information, or the like. The map data may be image data or point cloud data. The map data collection instruction may be sent to the executing body by other devices, or may be received from other applications installed on the executing body by the executing body. For example, the executing body may generate the map data collection instruction at a particular moment by setting a timing command.

Step 202, dividing the target road segment to obtain at least one sub-road segment.

In this embodiment, after receiving the map data collection instruction, the executing body may divide the target road segment to obtain the at least one sub-road segment. The executing body may divide the target road segment in various ways. For example, the executing body may perform the dividing according to the mileage of the target road segment. Alternatively, the executing body performs the dividing according to the number of intersections included in the target road segment. Alternatively, the executing body may perform the dividing according to the administrative region where the target road segment is located.

In some alternative implementations of this embodiment, step 202 may be implemented through the following steps not shown in FIG. 2: determining a length of the target road segment; dividing the target road segment according to the length of the target road segment, to obtain the at least one sub-road segment.

In this implementation, the executing body may divide the target road segment according to the length of the target road segment. In a plurality of obtained sub-road segments, the length of each sub-road segment is less than a first preset value. In this way, when the target road segment is long, the length of each sub-road segment may be made short, which is convenient for the collection of the map data.

In some alternative implementations of this embodiment, step 202 may be implemented through the following step not shown in FIG. 2: dividing the target road segment according to a road crossing point in the target road segment, to obtain the at least one sub-road segment.

In this implementation, the executing body may divide the target road segment according to the number of road crossing points included in the target road segment. The number of the road crossing points included in each obtained sub-road segment is less than a second preset value. Here, the road crossing points may refer to intersections, including a crossroad, a T-shaped intersection, and a Y-shaped intersection, etc. In a general situation, a traffic light is placed at an intersection. If the target road segment is divided according to the road crossing point, the time for waiting for the traffic light by the collection vehicle when collecting map data may be reduced.

Step 203, sending information of the at least one sub-road segment to at least one collection vehicle, to cause the at least one collection vehicle to collect map data of the at least one sub-road segment.

After dividing the target road segment, the executing body may send the information of the at least one sub-road segment obtained through the dividing to the at least one collection vehicle. Various data collection apparatuses such as a camera and a radar sensor may be installed on the collection vehicle. After receiving the information of the sub-road segment, the collection vehicle may collect the map data of the sub-road segment during the driving on the sub-road segment.

Further referring to FIG. 3, FIG. 3 is a schematic diagram of an application scenario of the method for collecting data according to this embodiment. In the application scenario of FIG. 3, the server receives the map data collection instruction for the target road segment. Then, the target road segment is divided into a plurality of sub-road segments according to the mileage and the road crossing points. Each sub-road segment may include a plurality of road crossing points, and the mileage of the each sub-road segment does not exceed 20 kilometers. Then, the information (the position, the name and the mileage) of each sub-road segment obtained through the division is sent to a plurality of collection vehicles. After obtaining the information of the respective sub-road segments, the collection vehicles may collect the map data when driving on the respective sub-road segments.

According to the method for collecting data provided by some embodiments of the present disclosure, the map data collection instruction for the target road segment maybe first received. Then, the target road segment is divided into the at least one sub-road segment. Finally, the information of the at least one sub-road segment is sent to the at least one collection vehicle, to cause the at least one collection vehicle to collect the map data of the at least one sub-road segment. Thus, the task of collecting the map data of the target road segment may be distributed to the plurality of collection vehicles, thereby improving the collection efficiency of the map data.

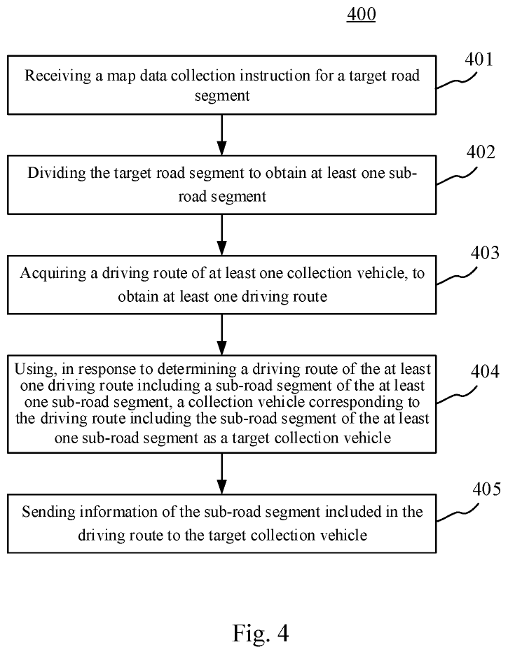

Further referring to FIG. 4, FIG. 4 illustrates a flow 400 of the method for collecting data according to another embodiment of the present disclosure. As shown in FIG. 4, the method in this embodiment may include the following steps.

Step 401, receiving a map data collection instruction for a target road segment.

Step 402, dividing the target road segment to obtain at least one sub-road segment.

Principles of steps 401-402 are the same as those of steps 201-202, which will not be repeatedly described here.

Step 403, acquiring a driving route of at least one collection vehicle, to obtain at least one driving route.

The executing body may acquire the driving route of the at least one collection vehicle, and thus may obtain the at least one driving route. When the collection vehicle is an autonomous driving vehicle, the driving route may be preset.

Step 404, using, in response to determining a driving route of the at least one driving route including a sub-road segment of the at least one sub-road segment, a collection vehicle corresponding to the driving route including the sub-road segment of the at least one sub-road segment as a target collection vehicle.

After obtaining the at least one driving route, the executing body may determine whether the driving route of the at least one driving route include the sub-road segment of the at least one sub-road segment. If the driving route include the sub-road segment, the executing body may use the driving route including the sub-road segment of the at least one sub-road segment as a target driving route. Then, the collection vehicle corresponding to the target driving route is used as the target collection vehicle.

Step 405, sending information of the sub-road segment included in the driving route to the target collection vehicle.

Finally, the executing body may send the information of the sub-road segment included in the target driving route to the target collection vehicle. The target collection vehicle may collect the map data of the sub-road segment when driving on the sub-road segment.

According to the method for collecting data provided by some embodiments of the present disclosure, the information of each sub-road segment maybe sent to the collection vehicle that is going to pass through the sub-road segment, and thus the collection cost may be effectively reduced.

In some alternative implementations of this embodiment, the method may further include the following steps not shown in FIG. 4: acquiring the map data collected by the at least one collection vehicle; and generating, according to the map data, an electronic map for the target road segment.

The executing body may further acquire the map data collected by each collection vehicle. The electronic map for the target road segment is then generated according to the map data. Specifically, the executing body may generate the electronic map according to the position of each object (a lane line, a median, a building, etc.) relative to the collection vehicle in the map data.

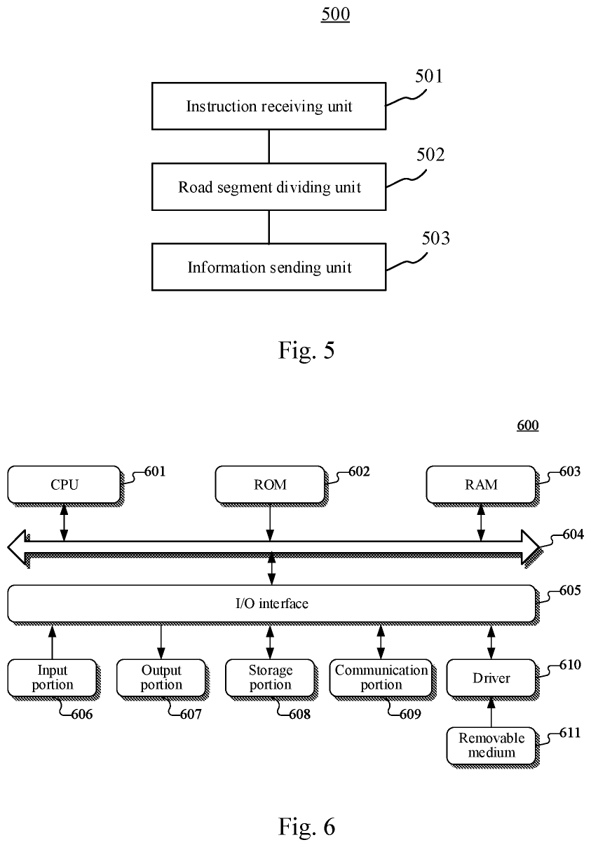

Further referring to FIG. 5, as an implementation of the method shown in the above drawings, some embodiments the present disclosure provide an apparatus for collecting data. An embodiment of the apparatus may correspond to the embodiment of the method shown in FIG. 2, and the apparatus may be applied in various electronic devices.

As shown in FIG. 5, the apparatus 500 for collecting data in this embodiment includes: an instruction receiving unit 501, a road segment dividing unit 502 and an information sending unit 503.

The instruction receiving unit 501 is configured to receive a map data collection instruction for a target road segment.

The road segment dividing unit 502 is configured to divide the target road segment to obtain at least one sub-road segment.

The information sending unit 503 is configured to send information of the at least one sub-road segment to at least one collection vehicle, to cause the at least one collection vehicle to collect map data of the at least one sub-road segment.

In some alternative implementations of this embodiment, the road segment dividing unit 502 may be further configured to: determine a length of the target road segment; and divide the target road segment according to the length of the target road segment, to obtain the at least one sub-road segment, a length of the sub-road segment being less than a first preset value.

In some alternative implementations of this embodiment, the target road segment includes at least one road crossing point. The road segment dividing unit 502 may be further configured to: divide the target road segment according to the at least one road crossing point in the target road segment, to obtain the at least one sub-road segment, a number of road crossing points included in the sub-road segment being less than a second preset value.

In some alternative implementations of this embodiment, the information sending unit 503 may include: a route acquiring module, a target determining module and an information sending module that are not shown in FIG. 5.

The route acquiring module is configured to acquire a driving route of the at least one collection vehicle, to obtain at least one driving route.

The target determining module is configured to use, in response to determining a driving route of the at least one driving route including a sub-road segment of the at least one sub-road segment, a collection vehicle corresponding to the driving route including the sub-road segment of the at least one sub-road segment as a target collection vehicle.

The information sending module is configured to send information of the sub-road segment included in the driving route to the target collection vehicle.

In some alternative implementations of this embodiment, the apparatus 500 may further include: a data acquiring unit and a map generating unit that are not shown in FIG. 5.

The data acquiring unit is configured to acquire the map data collected by the at least one collection vehicle.

The map generating unit is configured to generate, according to the map data, an electronic map for the target road segment.

According to the apparatus for collecting data provided by some embodiments of the present disclosure, the map data collection instruction for the target road segment maybe first received. Then, the target road segment is divided into the at least one sub-road segment. Finally, the information of the at least one sub-road segment is sent to the at least one collection vehicle, to cause the at least one collection vehicle to collect the map data of the at least one sub-road segment. Thus, the task of collecting the map data of the target road segment may be distributed to a plurality of collection vehicles, thereby improving the collection efficiency of the map data.

It should be understood that the units 501-503 described in the apparatus 500 for collecting data respectively correspond to the steps in the method described with reference to FIG. 2. Thus, the operations and features described for the method for collecting data are also applicable to the apparatus 500 and the units contained therein, which will not be repeatedly described herein.

Referring to FIG. 6, FIG. 6 is a schematic structural diagram of a computer system 600 adapted to implement a server of some embodiments of the present disclosure. The server shown in FIG. 6 is merely an example, and should not bring any limitations to the functions and the scope of use of some embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, etc.; an output portion 607 including a cathode ray tube (CRT), a liquid crystal display device (LCD), a speaker, etc.; a storage portion 608 including a hard disk or the like; and a communication portion 609 including a network interface card such as a LAN (local area network) card and a modem. The communication portion 609 performs communication processes via a network such as the Internet. A driver 610 is also connected to the I/O interface 605 as required. A removable medium 611 such as a magnetic disk, an optical disk, a magneto-optical disk, and a semiconductor memory may be installed on the driver 610, to facilitate the retrieval of a computer program from the removable medium 611, and the installation thereof on the storage portion 608 as needed.

In particular, according to embodiments of the present disclosure, the process described above with reference to the flow chart may be implemented as a computer software program. For example, an embodiment of the present disclosure includes a computer program product, including a computer program hosted on a computer readable medium, the computer program including program codes for performing the method as illustrated in the flowchart. In such an embodiment, the computer program may be downloaded and installed from a network via the communication portion 609, and/or may be installed from the removable medium 611. The computer program, when executed by the central processing unit (CPU) 601, implements the above mentioned functionalities defined in the methods of some embodiments of the present disclosure.

It should be noted that the computer readable medium in some embodiments of the present disclosure may be a computer readable signal medium, a computer readable storage medium, or any combination of the two. For example, the computer readable storage medium may be, but not limited to: an electronic, magnetic, optical, electromagnetic, infrared, or semiconductor system, apparatus, or element, or any combination of the above. A more specific example of the computer readable storage medium may include, but not limited to: an electrical connection having one or more wires, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above.

In some embodiments of the present disclosure, the computer readable storage medium may be any physical medium containing or storing programs, which may be used by a command execution system, apparatus or element or incorporated thereto. In some embodiments of the present disclosure, the computer readable signal medium may include a data signal that is propagated in a baseband or as a part of a carrier wave, which carries computer readable program codes. Such propagated data signal may be in various forms, including, but not limited to, an electromagnetic signal, an optical signal, or any suitable combination of the above. The computer readable signal medium may also be any computer readable medium other than the computer readable storage medium. The computer readable medium is capable of transmitting, propagating or transferring programs for use by, or used in combination with, a command execution system, apparatus or element. The program codes contained on the computer readable medium may be transmitted with any suitable medium including, but not limited to, wireless, wired, optical cable, RF medium, or any suitable combination of the above.

A computer program code for executing the operations according to some embodiments of the present disclosure may be written in one or more programming languages or a combination thereof. The programming language includes an object-oriented programming language such as Java, Smalltalk and C++, and further includes a general procedural programming language such as “C” language or a similar programming language. The program codes may be executed entirely on a user computer, executed partially on the user computer, executed as a standalone software package, executed partially on the user computer and partially on a remote computer, or executed entirely on the remote computer or a server. When the remote computer is involved, the remote computer may be connected to the user computer through any type of network, including a local area network (LAN) or a wide area network (WAN), or be connected to an external computer (e.g., connected through Internet provided by an Internet service provider).

The flowcharts and block diagrams in the accompanying drawings illustrate architectures, functions and operations that may be implemented according to the system, the method, and the computer program product of the various embodiments of the present disclosure. In this regard, each of the blocks in the flowcharts or block diagrams may represent a module, a program segment, or a code portion, the module, the program segment, or the code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed substantially in parallel, or they may sometimes be executed in a reverse sequence, depending on the function involved. It should also be noted that each block in the block diagrams and/or flowcharts as well as a combination of blocks may be implemented using a dedicated hardware-based system executing specified functions or operations, or by a combination of dedicated hardware and computer instructions.

The units involved in some embodiments of the present disclosure maybe implemented by means of software or hardware. The described units may also be provided in a processor. For example, the processor may be described as: a processor comprising an instruction receiving unit, a road segment dividing unit and an information sending unit. The names of these units do not in some cases constitute a limitation to such units themselves. For example, the instruction receiving unit may alternatively be described as “a unit for receiving a map data collection instruction for a target road segment.”

In another aspect, some embodiments of the present disclosure further provide a computer readable medium. The computer readable medium may be the computer readable medium included in the apparatus described in some embodiments, or a stand-alone computer readable medium not assembled into the apparatus. The computer readable medium carries one or more programs. The one or more programs, when executed by the apparatus, cause the apparatus to: receive a map data collection instruction for a target road segment; divide the target road segment to obtain at least one sub-road segment; and send information of the at least one sub-road segment to at least one collection vehicle, to cause the at least one collection vehicle to collect map data of the at least one sub-road segment.

The above description is only an explanation for embodiments of the present disclosure and the applied technical principles. It should be appreciated by those skilled in the art that the inventive scope of the present disclosure is not limited to the technical solution formed by the particular combinations of the above technical features. The inventive scope should also cover other technical solutions formed by any combinations of the above technical features or equivalent features thereof without departing from the concept of the disclosure, for example, technical solutions formed by replacing the features as disclosed in the present disclosure with (but not limited to) technical features with similar functions.

What is claimed is:

1. A method for collecting data, comprising:
receiving a map data collection instruction for a target road segment;
dividing the target road segment to obtain at least one sub-road segment; and
sending information of the at least one sub-road segment to at least one collection vehicle, to cause the at least one collection vehicle to collect map data of the at least one sub-road segment.

2. The method according to claim 1, wherein the dividing the target road segment to obtain at least one sub-road segment includes:
determining a length of the target road segment; and
dividing the target road segment according to the length of the target road segment, to obtain the at least one sub-road segment, a length of the sub-road segment being less than a first preset value.

3. The method according to claim 1, wherein the target road segment includes at least one road crossing point, and
the dividing the target road segment to obtain at least one sub-road segment includes:
dividing the target road segment according to the at least one road crossing point in the target road segment, to obtain the at least one sub-road segment, a number of road crossing points included in the sub-road segment being less than a second preset value.

4. The method according to claim 1, wherein the sending information of the at least one sub-road segment to at least one collection vehicle includes:
acquiring a driving route of the at least one collection vehicle, to obtain at least one driving route;
using, in response to determining a driving route of the at least one driving route including a sub-road segment of the at least one sub-road segment, a collection vehicle corresponding to the driving route including the sub-road segment of the at least one sub-road segment as a target collection vehicle; and
sending information of the sub-road segment included in the driving route to the target collection vehicle.

5. The method according to claim 1, further comprising:
acquiring the map data collected by the at least one collection vehicle; and
generating, according to the map data, an electronic map for the target road segment.

6. An apparatus for collecting data, comprising:
at least one processor; and
a memory storing instructions, the instructions when executed by the at least one processor, cause the at least one processor to perform operations, the operations comprising:
receiving a map data collection instruction for a target road segment;
dividing the target road segment to obtain at least one sub-road segment; and
sending information of the at least one sub-road segment to at least one collection vehicle, to cause the at least one collection vehicle to collect map data of the at least one sub-road segment.

7. The apparatus according to claim 6, wherein the dividing the target road segment to obtain at least one sub-road segment includes:
determining a length of the target road segment; and
dividing the target road segment according to the length of the target road segment, to obtain the at least one sub-road segment, a length of the sub-road segment being less than a first preset value.

8. The apparatus according to claim 6, wherein the target road segment includes at least one road crossing point, and
the dividing the target road segment to obtain at least one sub-road segment includes:
dividing the target road segment according to the at least one road crossing point in the target road segment, to obtain the at least one sub-road segment, a number of road crossing points included in the sub-road segment being less than a second preset value.

9. The apparatus according to claim 6, wherein the sending information of the at least one sub-road segment to at least one collection vehicle includes:
acquiring a driving route of the at least one collection vehicle, to obtain at least one driving route;
using, in response to determining a driving route of the at least one driving route including a sub-road segment of the at least one sub-road segment, a collection vehicle corresponding to the driving route including the sub-road segment of the at least one sub-road segment as a target collection vehicle; and
sending information of the sub-road segment included in the driving route to the target collection vehicle.

10. The apparatus according to claim 6, the operations further comprising:
acquiring the map data collected by the at least one collection vehicle; and
generating, according to the map data, an electronic map for the target road segment.

11. A non-transitory computer readable medium, storing a computer program, wherein the computer program, when executed by a processor, causes the processor to perform operations, the operations comprising:
receiving a map data collection instruction for a target road segment;
dividing the target road segment to obtain at least one sub-road segment; and
sending information of the at least one sub-road segment to at least one collection vehicle, to cause the at least one collection vehicle to collect map data of the at least one sub-road segment.
